(19) United States
(12) Patent Application Publication
(10) Pub. No.: US 2002/0192014 A1
(43) Pub. Date: Dec. 19, 2002

(54) Connector for a flexible rod

(76) Inventor: Alvin De Villiers, Kwa zulu Natal (ZA)

Correspondence Address: YOUNG & THOMPSON, 745 SOUTH 23RD STREET 2ND FLOOR, ARLINGTON, VA, 22202

(21) Appl. No.: 10/143,872

(22) Filed: May 14, 2002

(30) Foreign Application Priority Data
Jun. 19, 2001 (ZA) F2001/0609

(51) Int. Cl. F16D 1/12

(52) U.S. Cl. 403/78

(57) ABSTRACT

A swivel arrangement which has particular application to banners, flags and the like, such as banners comprising a closed frame of spring steel or other material the frame carrying a sheet of material stitched to the frame. The frame is twisted and folded on itself to constitute a small circular article which is easily stored if constrained against springing open again. When required for use the article “pops up”. The material contains advertising or other information and these are used extensively for many applications.

### FIELD OF THE INVENTION

This invention relates to a swivel arrangement which has particular application to banners, flags and the like, such as banners comprising a closed frame of spring steel or other material the frame carrying a sheet of material stitched to the frame. The frame is twisted and folded on itself to constitute a small circular article which is easily stored if constrained against springing open again. When required for use the article “pops up”. The material contains advertising or other information and these are used extensively for many applications.

It will be appreciated that the swivel may be used in a number of other applications involving the need for relative longitudinal or rotary movement between two members.

### BACKGROUND OF THE INVENTION

The conventional banner of this type is extremely difficult if not impossible to fold into a figure of eight, especially large banners and it is only possible to adopt a multiple folding and twisting action.

This is well illustrated in U.S. Pat. Nos. 5,116,273 (Chan) and 5,845,697 (Zheng).

In the first of these a spring wire hoop 14 is contained in a hem 12 and its ends are joined by a rigid junction sleeve 27 which is formed and stamped around the ends. When twisted the hoop forms into concentric loops in the same manner as in the later patent where it acknowledges that the loops suffer from the drawback that they are not easy to use because they are difficult to twist and fold because of the tendency to return to their original expanded condition. Thus, the invention of the Zheng patent is aimed at avoiding the concomitant danger involved in this situation, whereby the sheath accommodating the free ends of the loop prevents fracture and resulting dangers by virtue of its encapsulating the ends.

It has now been found that, irrespective of the cross sectional shape of the frame, the folding operation can be simplified still further, for example by first forming it into a figure of 8 and this is the object of the present invention. Thus, a frame of circular cross section, which in the prior art was found to be very difficult to twist, can now be utilized.

### THE INVENTION

According to the invention a swivel arrangement for a banner or the like includes a closed spring loop and a connector for the free ends thereof, the ends being swivelable with respect to each other and/or the connector.

The spring may be of steel of other suitable metal but may also be of a polymeric substance, such as fibre-reinforced plastic material.

In a preferred form of the invention the loop is encapsulated in a hem which may be portion of a sheet of material spanning the loop and which may have advertising or other information printed thereon.

In one form of the invention the connector comprises a double-ended ferrule having a circular bore to receive the ends of a circular loop. In existing banners the use of a circular loop imports a difficulty for it to be twisted to achieve a collapsed condition as required for storage purposes. Nevertheless, a circular cross-section is the most readily available cross-sectional shape and one of the objects of the present invention is to utilise such cross-sectional shape but in a manner which permits easy use. The double ferrule is ideal for this purpose.

The ends of the loop of wire are under a tension which biases them to fly apart but for the restraining effect of the hem and this tension ensures that the ends are held in the two ends of the ferrule and, at the same time, are able to swivel therein when the article is required to be collapsed.

In another form of the invention a connector is provided which takes the form of a double ferrule in two mutually swivelable portions, each portion accepting an end of the loop. The loop may have any cross section and the ferrule openings will have corresponding cross section. The portions may be joined by a ball-and-socket joint.

### EMBODIMENTS OF THE INVENTION

Two embodiments of the invention are described below with reference to the accompanying drawings, in which:

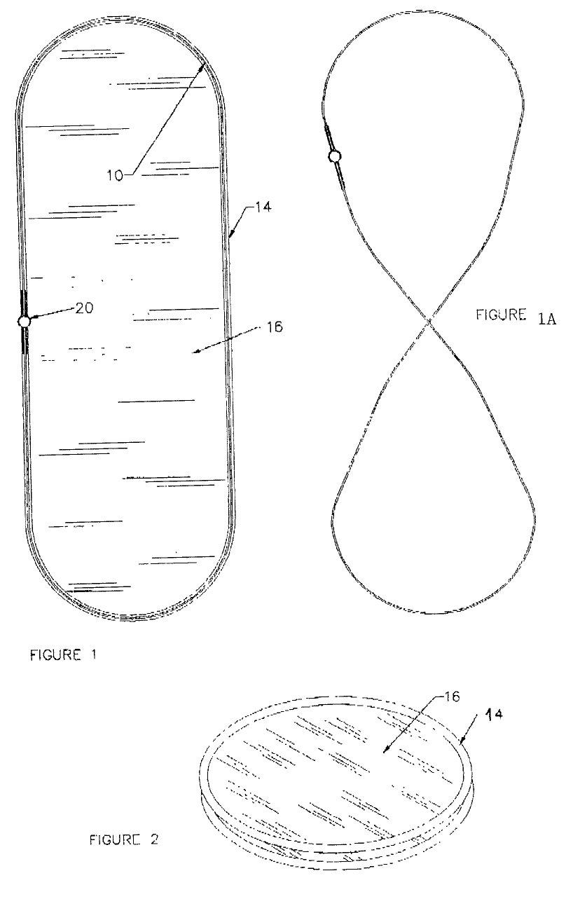

FIG. 1 is a front view of a banner incorporating the present invention in its expanded condition;

FIG. 2 is a similar view of the banner in its collapsed condition;

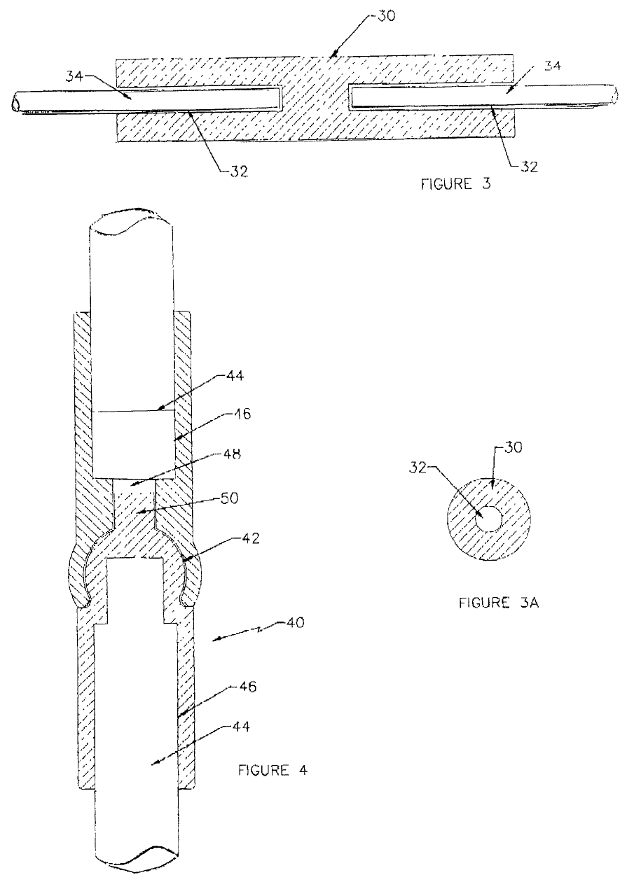

FIG. 3 is a sectional side view of a connector according to the invention; and

FIG. 4 is a similar view of another form of the invention.

In the drawings a length of glass fibre reinforced plastic 10 is formed into a loop, in this case in the shape of a lozenge but it will be appreciated that many other shapes may be provided depending on requirements and aesthetics.

The loop is constrained in a hem 14 of a sheet 16 of suitable material which may include advertising or other information or pattern.

A connector 20 receives the two free ends of the loop in a manner which permits easy twisting of the loop, as will be described below.

In FIG. 1 the banner is in its expanded condition. This is twisted into a figure of 8 (FIG. 1A) and the two halves of the 8 folded together to achieve a collapsed condition as shown in FIG. 2.

Two examples of connectors useful in the practice of this invention are illustrated in FIGS. 3 and 4 but it will be appreciated that other forms of connector will also fall within the ambit of the invention provided the ends of the loop are swivelable with relation to each other, or the connector is formed in two portions which are mutually swivelable.

In FIG. 3 the connector 30 is a simple double ferrule with orifices 32 at either end. These orifices are circular in bore and receive corresponding circular ends 34 of the loop. As mentioned above the natural tension of the loop ensures that the ends are held in the orifices and yet they are able to swivel therein. This ability to swivel renders it very easy to fold the banner into a figure of 8 and thereafter to fold the two halves of the 8 into the collapsed condition.

In FIG. 4 the connector 40 itself is a swivel by virtue of a ball-and-socket joint 42. The ends 44 of the loop are inserted into the orifices 46. The loop may be of any cross section, the orifices having corresponding bore. Although more complicated than the ferrule of FIG. 3, this connector permits the use of function fit ends of the loop to establish a secure structure. The socket portion includes a short passage 48 to receive a pin 50 of the ball portion to rigidify the structure.

1. A swivel arrangement for a banner or the like includes a closed spring wire loop and a connector for the free ends thereof, the ends being swivelable with respect to each other and/or the connector.

2. The swivel arrangement according to claim 1 in which the spring wire is of steel or other metal or of a polymeric substance.

3. The swivel arrangement according to claim 1 or 2 in which the loop is encapsulated in a hem which may be portion of a sheet of material spanning the loop.

4. The swivel arrangement according to any of the above claims in which the connector comprises a double-ended ferrule having a circular bore to receive the ends of a circular loop.

5. The swivel arrangement according to any of claims 1 to 3 in which the connector takes the form of a double ferrule in two mutually swivelable portions, each portion accepting an end of the loop.

6. The swivel arrangement according to claim 5 in which the portions are joined by a ball-and-socket joint.
